(19) United States
(12) Patent Application Publication
(10) Pub. No.: US 2004/0021302 A1
(43) Pub. Date: Feb. 5, 2004

(54) Method of accommodating stepping movement in a walking beam assembly that has air suspension, and a walking beam assembly with air suspension

(76) Inventor: Raymond William English, Edmonton (CA)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/420,338

(22) Filed: Apr. 18, 2003

(30) Foreign Application Priority Data
Apr. 19, 2002 (CA) 2,382,726

(51) Int. Cl. B60G 5/00

(52) U.S. Cl. 280/678

(57) ABSTRACT

A method of accommodating stepping movement in a walking beam assembly that has air suspension and a walking beam assembly with air suspension which includes a saddle and a pair of walking beams pivotally mounted in parallel spaced apart relation to the saddle. Supports for air bags are positioned on the saddle. A frame bracket is provided which is adapted for mounting to a chassis of a vehicle. The saddle is pivotally mounted to the frame bracket by a pivot bearing. In accordance with the teachings of the invention, the pivot bearing includes a housing and a ball having integral support shafts extending outwardly in opposed relation. The ball is supported within the housing for limited omnidirectional movement. In addition to accommodating up and down pivotal movement of the saddle, this configuration of pivot bearing accommodates limited yaw and limited roll.

### FIELD OF THE INVENTION

The present invention relates to a method of accommodating stepping movement in a walking beam assembly that has air suspension, and a walking beam assembly with air suspension.

### BACKGROUND OF THE INVENTION

Canadian Patent 2,041,998 (Kooistra 1994 now owned by Raydan Manufacturing Inc.) and corresponding U.S. Pat. No. 5,228,718 (Kooistra 1993 now owned by Paydan Manufacturing Inc.) teach a walking beam construction that utilizes air suspension.

The present invention in intended to provide improved performance when manoeuvring through uneven terrain. More particularly, the present invention is intended to more evenly distribute weight when a vehicle is traversing a side of a hill or stepping over obstacles.

### SUMMARY OF THE INVENTION

According to one aspect of the present invention there is provided a walking beam assembly with air suspension which includes a saddle and a pair of walking beams pivotally mounted in parallel spaced apart relation to the saddle. Supports for air bags are positioned on the saddle. A frame bracket is provided which is adapted for mounting to a chassis of a vehicle. The saddle is pivotally mounted to the frame bracket by a pivot bearing. In accordance with the teachings of the invention, the pivot bearing includes a housing and a ball having integral support shafts extending outwardly in opposed relation. The ball is supported within the housing for limited omnidirectional movement. In addition to accommodating up and down pivotal movement of the saddle, this configuration of pivot bearing accommodates limited yaw and limited roll.

According to another aspect of the present invention there is provided a method of accommodating stepping movement in a walking beam assembly that has air suspension. A first step involves providing a walking beam assembly with air suspension as described above. A second step involves mounting the saddle to the frame bracket by means of a pivot bearing that includes a housing and a ball having integral support shafts extending outwardly in opposed relation. The ball is supported within the housing for limited omnidirectional movement. In addition to up and down pivotal movement, the saddle is capable of limited yaw and limited roll.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1, labelled as PRIOR ART, is a side elevation view of a walking beam assembly with air suspension.

FIG. 2 labelled as PRIOR ART, is a top plan view of the walking beam assembly with air suspension illustrated in FIG. 1.

FIG. 3 is a side elevation view of a walking beam assembly with air suspension constructed in accordance with the teachings of the present invention.

FIG. 4 is a top plan view of the walking beam assembly with air suspension illustrated in FIG. 3.

FIG. 5 is an end elevation view, in section, of the walking beam assembly taken along section lines A-A of FIG. 3.

FIG. 6 is an end elevation view, in section, of the walking beam assembly taken along section lines B-B of FIG. 3.

FIG. 7 is a side elevation view of the frame bracket and pivot bearing from the walking beam assembly with air suspension illustrated in FIG. 3.

FIG. 8 is an end elevation view, in section, of the frame bracket and pivot bearing illustrated in FIG. 7, with pivot bearing in a substantially horizontal orientation.

FIG. 9 is an end elevation view, in section, of the frame bracket and pivot bearing illustrated in FIG. 7, with pivot bearing in an angular orientation.

FIG. 10 is a side elevation view of the walking beam assembly with air suspension illustrated in FIG. 3.

FIG. 11 is a side elevation view of the walking beam assembly with air suspension illustrated in FIG. 3.

FIG. 12 is a perspective view of the walking beam assembly with air suspension illustrated in FIG. 3.

### DETAILED DESCRIPTION OF THE PREFERRED EMBODIMENT

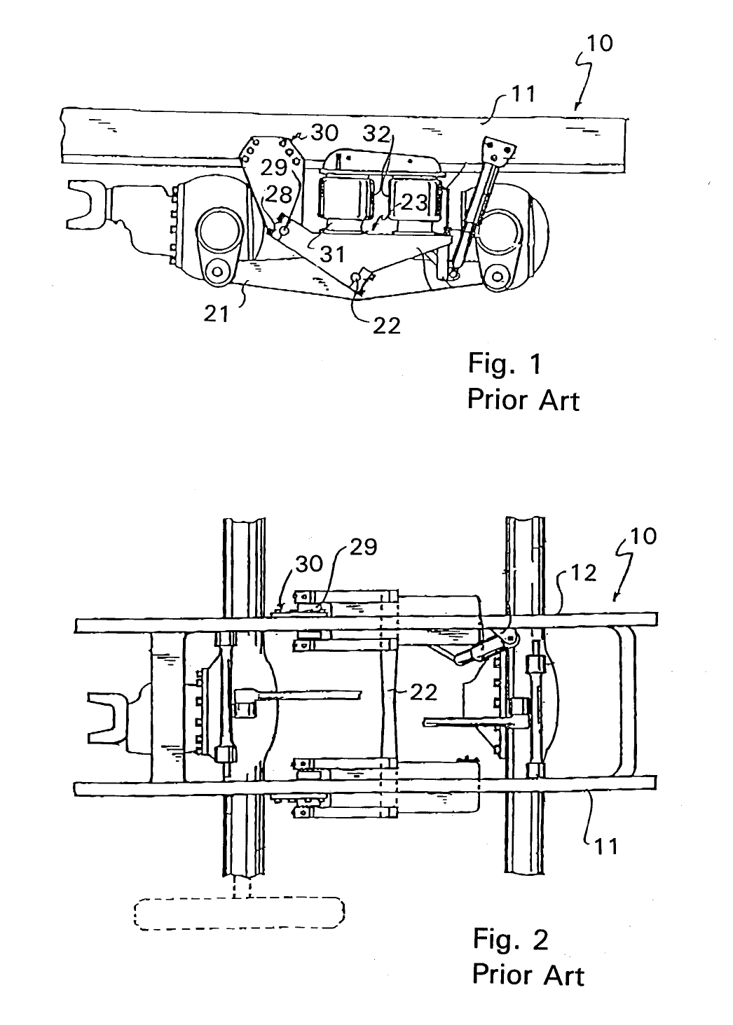

A PRIOR ART walking beam assembly with air suspension generally identified by reference numeral 10, will first be described with reference to FIGS. 1 and 2.

Referring to FIGS. 1 and 2, PRIOR ART walking beam assembly 10 included a pair of walking beams 21 connected by a transverse pivot 22 to a saddle 23. Mounted to saddle 23 were supports 31 for air bags 32. Saddle 23 was mounted to vehicular chassis members 11 and 12 by cylindrical pivot bearings 29 which engaged frame brackets 30. Saddle 23 pivoted about a substantially horizontal pivot axis provided by pivot bearings 29 to accommodate up and down movement of saddle 23.

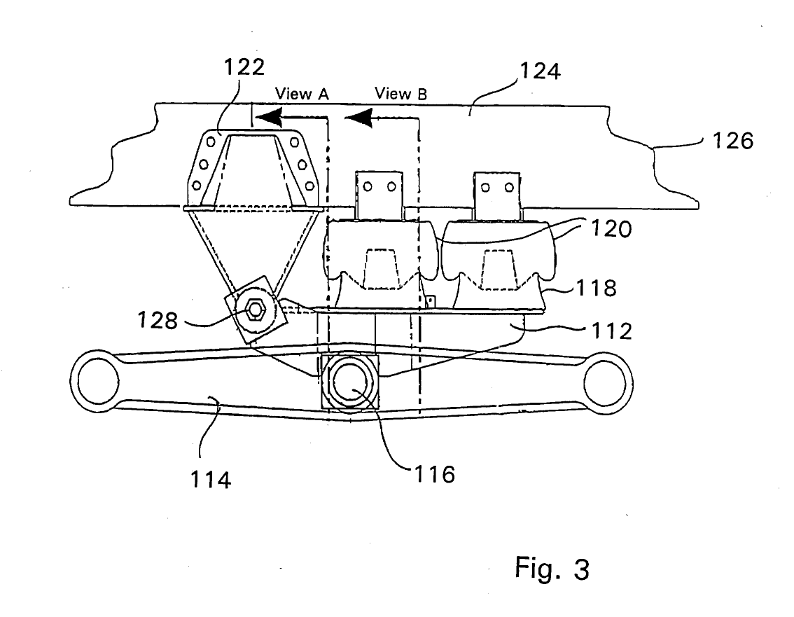

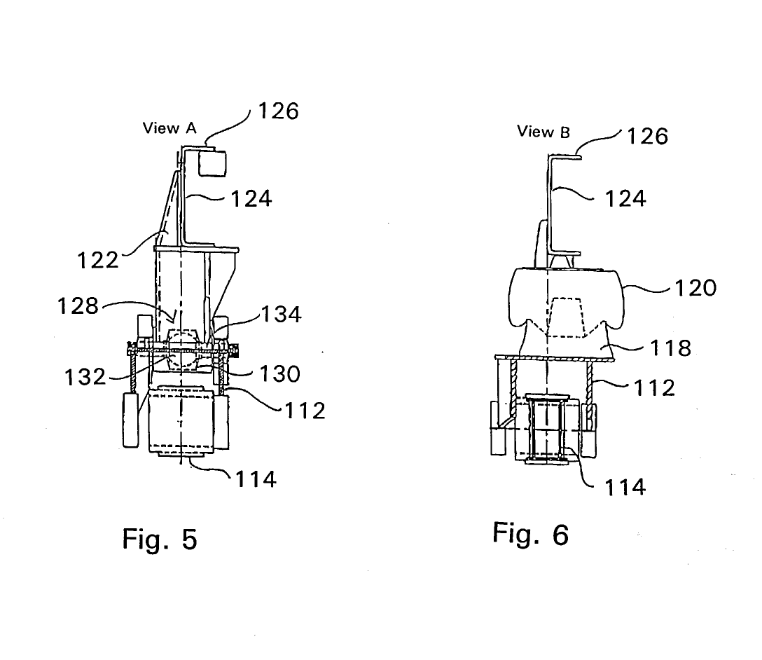

The preferred embodiment, a walking beam assembly with air suspension generally identified by reference numeral 100, will now be described with reference to FIGS. 3 through 12.

Structure and Relationship of Parts:

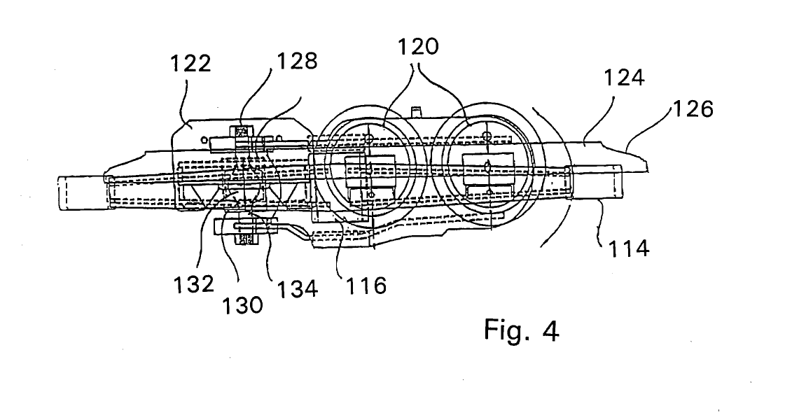

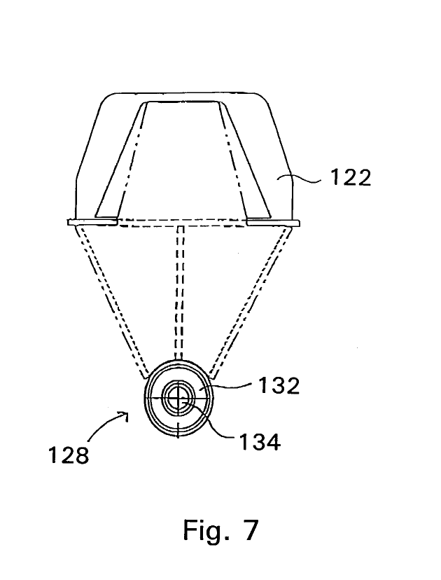

Referring to FIG. 3, there is provided a walking beam assembly 100 that includes a saddle 112 and a pair of walking beams 114 pivotally mounted to saddle 112 by transverse pivots 116 in parallel spaced apart relation Referring to FIGS. 3 and 6, supports 118 for air bags 120 are positioned on saddle 112. Referring to FIG. 3 and 4, a frame bracket 122 is provided that is adapted for mounting to a chassis 124 of a vehicle 126. Referring to FIGS. 7 through 9, frame bracket 122 has a pivot bearing, generally referenced by numeral 128.

Referring to FIG. 3, saddle 112 is pivotally mounted to frame bracket 122 by pivot bearing 128.

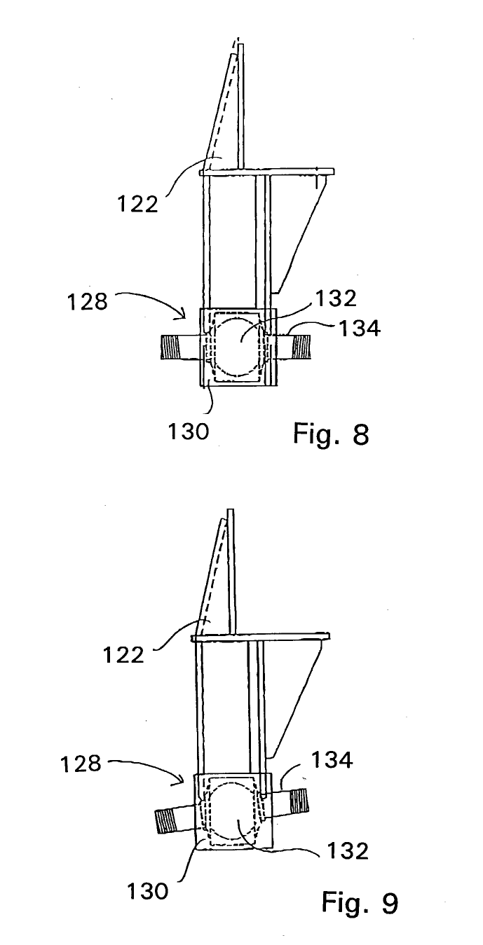

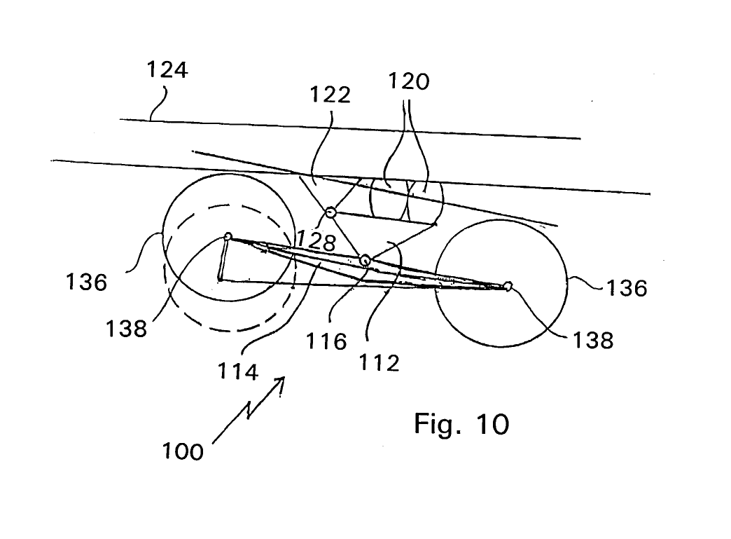

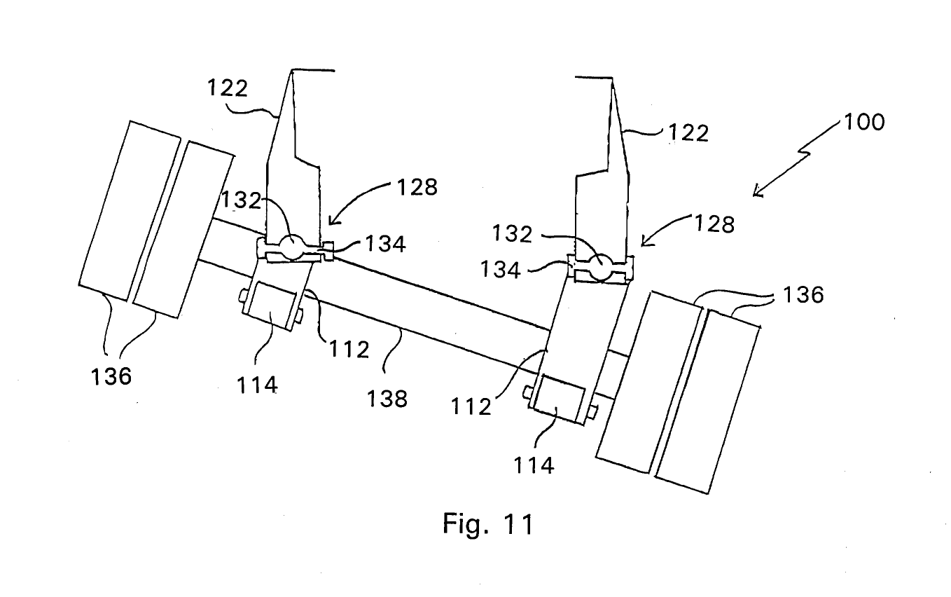

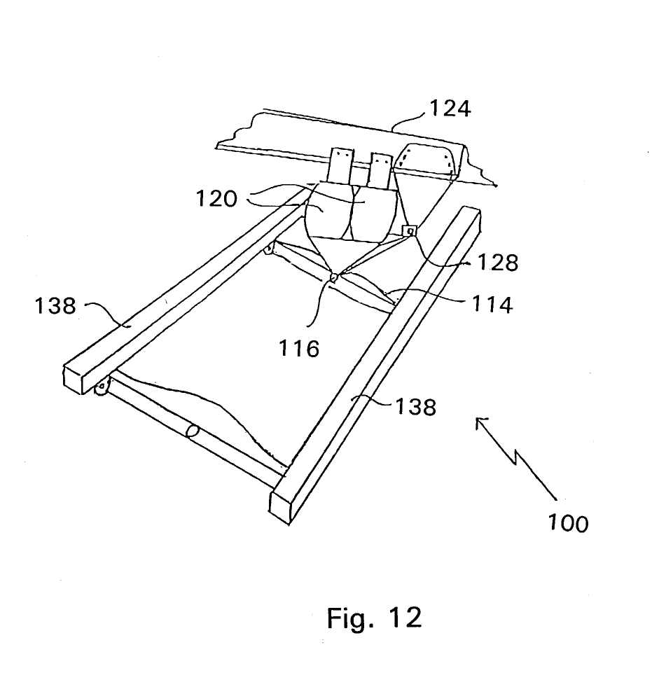

Referring to FIGS. 8 and 9, pivot bearing 128 includes a housing 130 and a ball 132 with integral support shafts 134 extending outwardly in opposed relation. Ball 132 is supported within housing 130 for limited omnidirectional movement such that in addition to accommodating up and down pivotal movement of saddle 112, as illustrated in FIG. 10, pivot bearing 128 accommodates limited yaw as illustrated in FIGS. 4 and 12, and limited roll as illustrated in FIGS. 9 and 11.

Operation:

The use and operation of walking beam assembly with air suspension generally identified by reference numeral 100, will now be described with reference to FIGS. 3 through 12. When walking beam assembly is positioned on a level surface pivot bearing 128 will be positioned with integral support shafts 134 in a substantially horizontal orientation, as illustrated in FIG. 8. It will be understood that with pivot bearing 128 in this orientation saddle 112 will pivot up and down about the horizontal axis provided by integral support shafts 134 in a manner that is similar to the prior art, as illustrated in FIG. 10. However, when one wheel 136 on an axle 138 begins to climb to step over an object such as a fallen tree, pivot bearing 128 will alter its orientation to an angular orientation as illustrated in FIGS. 9 and 11. This will cause the orientation of saddle 112 to also assume an angular orientation. At the same time this will cause saddle 112 to shift laterally as illustrated in FIGS. 4 and 12.

The prior art walking beam assembly 10 illustrated in FIGS. 1 and 2, did not allow saddle 23 to rotate with walking beams 21. Saddle 23 was at all times held level by pivot bearings 29. In contrast, it can be seen how pivot bearing 128, as described above and illustrated in FIGS. 11 and 12, accommodates limited roll and limited yaw of saddle 112. This allows saddle 112 to follow the rotational movement of walking beam 114 as one wheel 136 climbs over an obstacle, and weight is distributed more equally between the wheels 136.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the claims.

The embodiments of the invention in which an exclusive property or privilege is claimed are defined as follows:

1. A walking beam assembly with air suspension, comprising:
a saddle;
a pair of walking beams pivotally mounted in parallel spaced apart relation to the saddle;
supports for air bags positioned on the saddle;
a frame bracket adapted for mounting to a chassis of a vehicle, the saddle being pivotally mounted to the frame bracket by a pivot bearing, the pivot bearing comprising:
a housing;
a ball having integral support shafts extending outwardly in opposed relation, the ball being supported within the housing for limited omnidirectional movement such that in addition to accommodating up and down pivotal movement of the saddle the pivot bearing accommodates limited yaw and limited roll.

2. A method of accommodating stepping movement in a walking beam assembly that has air suspension, comprising the steps of:
providing a walking beam assembly with air suspension that includes a saddle, a pair of walking beams pivotally mounted in parallel spaced apart relation to the saddle, supports for air bags positioned on the saddle, a frame bracket adapted for mounting to a chassis of a vehicle;
mounting the saddle to the frame, bracket by means of a pivot bearing that includes
a housing;
a ball having integral support shafts extending outwardly in opposed relation, the ball being supported within the housing for limited omnidirectional movement, such that, in addition to up and down pivotal movement, the saddle is capable of limited yaw and limited roll.
